(19) United States
(12) Patent Application Publication
(10) Pub. No.: US 2004/0104905 A1
(43) Pub. Date: Jun. 3, 2004

(54) Apparatus capable of controlling brightness switching between a protable device and a docking station

(75) Inventors: Show-Nan Chung, Sinjhuang City (TW); Chin-Peng Tsai, Sindian City (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei City (TW)

(21) Appl. No.: 10/692,749

(22) Filed: Oct. 27, 2003

(30) Foreign Application Priority Data
Dec. 2, 2002 (TW) 91219425

(51) Int. Cl. G09G 5/00

(52) U.S. Cl. 345/204

(57) ABSTRACT

An apparatus for controlling brightness switching between a portable means and a docking station is provided. The apparatus comprises detection device for generating an installation correctness signal when the portable device is correctly mounted on the docking station. The signal selector includes a first input pin in a connector coupled to a mated connector of the docking station for receiving a brightness control signal from the docking station, and a second input pin for receiving a brightness control signal from the portable device. The signal of the first input pin is selected for output when the signal selector receives the installation correctness signal from the detection device.

### BACKGROUND OF THE INVENTION

1. Field of the Invention

The present invention relates to the technical field of brightness control of a portable device and, more particularly, to an apparatus capable of controlling brightness switching between a portable device and a docking station.

2. Description of Related Art

As a result of technological developments of electronics, a wide variety of powerful, inexpensive electronic devices (e.g., palm computers, PDAs (personal digital assistants), tablet PCs (personal computers), smart display, and the like) are commercially available. As shown in FIG. 1, a portable device (e.g., smart display) 10 includes a connector 11 coupled to a mated connector 21 of a docking station 20 so that a rechargeable battery of the portable device 10 can be recharged by the docking station 20 or the portable device 10 and the PC 30 can be in signal communication via the docking station 20. The portable device 10 further comprises a plurality of buttons 12 in which one of the buttons is used to adjust the brightness of the portable device 10.

However, the prior art suffered from a disadvantage in that stress can be concentrated and accumulated on the docking station 20 and/or the connector 11 when a user pushes the button to adjust the brightness of the portable device 10 fastened at the docking station 20. Also, the fastening of the portable device 10 at the docking station 20 can be compromised after a relatively long period of time of the adjustment, and thus it is desirable to provide an improved apparatus for controlling brightness switching between a portable device and a docking station to mitigate and/or obviate the aforementioned problems.

### SUMMARY OF THE INVENTION

The object of the present invention is to provide an apparatus for controlling brightness switching between a portable device and a docking station so that in response to correctly mounting the portable device on the docking station, the brightness of the portable device can be controlled by pushing a button of the docking station.

According to a feature of the present invention, there is provided an apparatus for controlling brightness switching between a portable devices and a docking station. The apparatus includes a detection device and a signal selector. The detection device generates an installation correctness signal when the portable device is correctly mounted on the docking station. The signal selector comprises a first input pin and a second input pin. The first input pin is coupled to a connector of the docking station for receiving a brightness control signal from the docking station, and the second input pin is coupled to a connector of the docking station for receiving a brightness control signal from the portable device, wherein the installation correctness signal is selected for output from the first input pin when the signal selector receives the installation correctness signal from the detection device.

Other objects, advantages, and novel features of the invention will become more apparent from the detailed description when taken in conjunction with the accompanying drawings.

### BRIEF DESCRIPTION OF THE DRAWINGS

FIG. 1 is a perspective view of a conventional docking station for connecting a portable device;

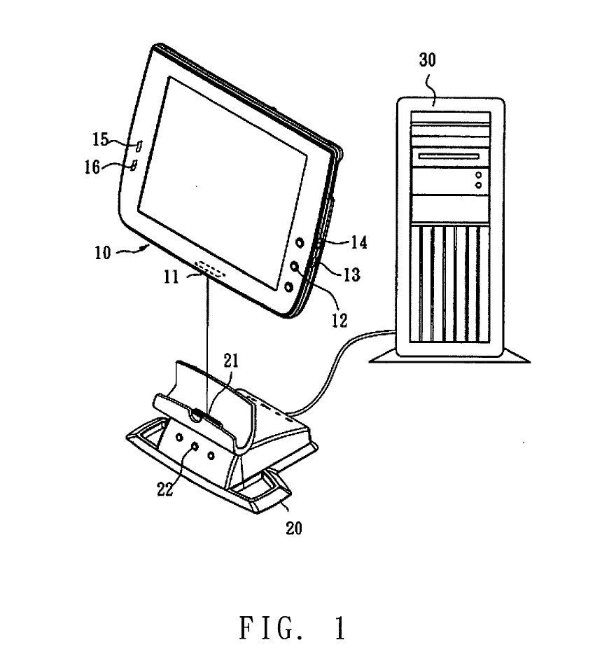

FIG. 2 is a block diagram of an apparatus for controlling brightness switching between a portable device and a docking station in accordance with the invention; and

FIG. 3 is a circuit diagram of a signal selector and other associated components shown in FIG. 2.

### DETAILED DESCRIPTION OF THE PREFERRED EMBODIMENT

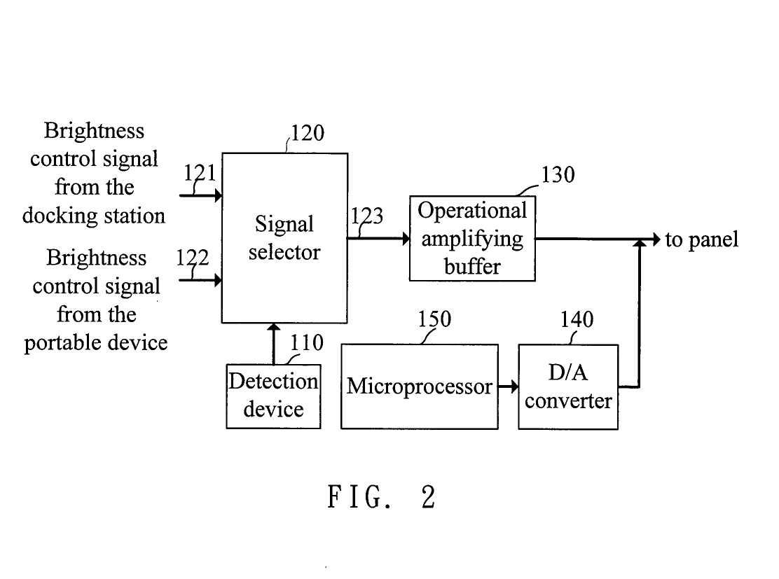

With reference to FIG. 2, there is shown an apparatus for controlling brightness switching between a portable device 10 (e.g., smart display) and a docking station 20 coupled to a PC 30 in accordance with the invention. The apparatus for controlling brightness switching comprises a detection device 110, a signal selector 120, an amplifier buffer 130, a D/A converter 140 and a micro-controller 150. The detection device 110 generates an installation correctness signal when the portable device 10 is correctly mounted on the docking station 20, and the signal selector 120 comprises a first input pin 121 in a connector 11 coupled to a mated connector 21 of the docking station 20 for receiving a brightness control signal from the docking station 20, and a second input pin 122 for receiving a brightness control signal from the portable device 10. The signal from the first input pin 121 will be outputted when the signal selector 120 receives the installation correctness signal from the detection device 110.

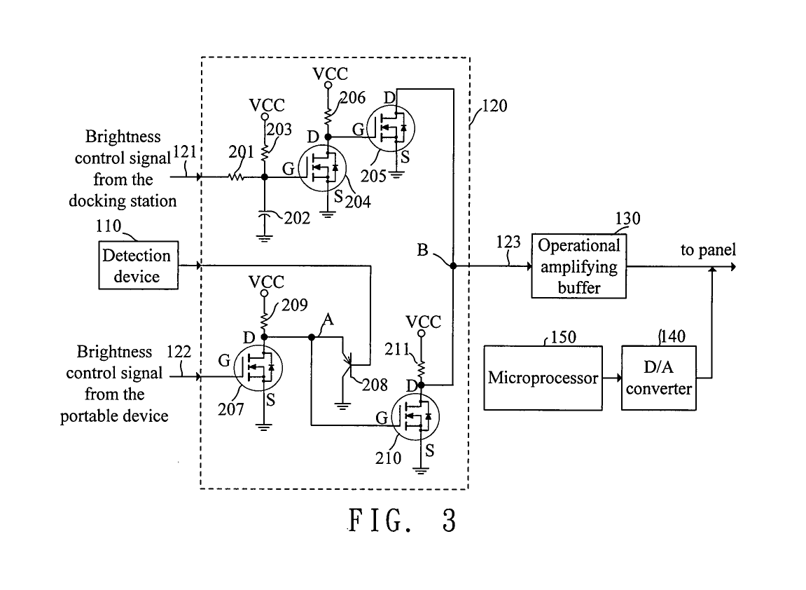

With reference to FIG. 3, the signal selector 120 comprises a first to fifth resistor 201, 203, 206, 209 and 211, a first capacitor 202, and a first to fifth transistor 204, 205, 207, 208 and 210. The transistors 204, 205, 207, and 210 are N-channel logic level enhancement mode field effect transistor and the fourth transistor 208 is a PNP transistor.

The gate of the first transistor 204 is coupled to the first capacitor 202, the second resistor 203, and the first resistor 201 respectively. The first resistor 201 is in turn coupled to the first input pin 121. The first capacitor 202 is electrically grounded (i.e., low level). The second resistor 203 is coupled to Vcc (i.e., high level). The source of the first transistor 204 is electrically grounded (i.e., low level) and the drain thereof is coupled to the third resistor 206 and the gate of the second transistor 205 respectively in which the third resistor 206 is in turn coupled to Vcc (i.e., high level). The source of the second transistor 205 is electrically grounded (i.e., low level).

The second input pin 122 is coupled to the gate of the third transistor 207. The source of the third transistor 207 is electrically grounded (i.e., low level) and the drain thereof is coupled to the emitter of the fourth transistor 208, the fourth resistor 209, and the gate of the fifth transistor 210 respectively. The fourth resistor 209 is in turn coupled to Vcc (i.e., high level). The base of the fourth transistor 208 is coupled to the detection device 110 for receiving the installation correctness signal therefrom and the collector thereof is electrically grounded (i.e., low level). The source of the fifth transistor 210 is electrically grounded (i.e., low level) and the drain thereof is coupled to the drain of the second transistor 205, the fifth resistor 211, and the output 123 of the signal selector 120 respectively in which the fifth resistor 211 is in turn coupled to Vcc (i.e., high level).

When the portable device 10 is correctly mounted on the docking station 20, an installation correctness signal with a low level voltage will be generated by the detection device 110. The fourth transistor 208 is thus conducted by the installation correctness signal. At the moment, point A is at a low voltage. As such, the PWM (pulse width modulation) brightness control signal from the portable device 10 is blocked, and the PWM brightness control signal from the docking station can be fed to a panel of the portable device.

When the portable device 10 is not correctly mounted on the docking station 20, an installation correctness signal will not be generated by the detection device 110 at high level. The fourth transistor 208 is thus turned off by the installation correctness signal. At the moment, the PWM brightness control signal from the portable device 10 can be fed to the panel the portable device. Because the portable device 10 is not correctly mounted on the docking station 20, thus the PWM based brightness control signal from the docking station 20 is blocked. As an end, the PWM based brightness control signal from the portable device 10 and the PWM based brightness control signal from the docking station 20 are combined at point B.

The transistors 204, 205, 207, and 210 are served as inverters. As such, the PWM based brightness control signal from the docking station 20 or the portable device 10 can be inverted two consecutive times for returning to itself but having an improved electrical characteristic. The device for controlling brightness switching of the invention further comprises an operational amplifying buffer 130 coupled to the output 123 of the signal selector 120 for increasing the driving capability of the portable device 10.

The device for controlling brightness switching of the invention further comprises a microprocessor 150, and a DAC (digital-to-analog converter) 140. The DAC comprises an input pin coupled to an output pin of the microprocessor 150 and an output pin coupled to the output of the operational amplifying buffer 130. The microprocessor 150 is adapted to execute a program for generating a PWM brightness control signal to control the brightness of the portable device 10. In another embodiment, the DAC 140 is integrated into the microprocessor 150.

In view of the foregoing, it is known that the signal selector 120 can send PWM brightness control signal from either the portable device 10 or the docking station 20 to the panel of the portable device 10. In response to correctly mounting the portable device 10 on the docking station 20, the brightness of the portable device 10 can be controlled by pushing a button on the docking station 20. Alternatively, the brightness control can be carried out by software.

Although the present invention has been explained in relation to its preferred embodiment, it is to be understood that many other possible modifications and variations can be made without departing from the spirit and scope of the invention as hereinafter claimed.

What is claimed is:

1. An apparatus for controlling brightness switching between a portable device and a docking station, comprising:
a detection device for generating an installation correctness signal when the portable device is correctly mounted on the docking station; and
a signal selector comprising a first input pin in a connector coupled to a mated connector of the docking station for receiving a brightness control signal from the docking station, and a second input pin for receiving a brightness control signal from the portable device,
wherein the signal of the first input pin is selected for output when the signal selector receives the installation correctness signal from the detection device.

2. The apparatus as claimed in claim 1, wherein the signal selector comprises first to fifth resistors, a first capacitor, and first to fifth transistors, the first input pin being connected to the first capacitor, the second resistor, and a gate of the first transistor respectively, the first capacitor being connected to a low level, the second resistor being connected to a high level, a source of the first transistor being at a low level and a drain thereof being coupled to the third resistor and a gate of the second transistor respectively, the third resistor being at a high level, a source of the second transistor being at a low level, the second input pin being coupled to a gate of the third transistor, the source of the third transistor being at a low level and a drain thereof being coupled to an emitter of the fourth transistor, the fourth resistor, and a gate of the fifth transistor respectively, the fourth resistor being at a high level, a base of the fourth transistor being coupled to the detection device for receiving the installation correctness signal therefrom and an emitter thereof being at a low level, a source of the fifth transistor being at a low level and a drain thereof being coupled to a drain of the second transistor, the fifth resistor, and an output of the signal selector respectively, and the fifth resistor being at a high level.

3. The apparatus as claimed in claim 1, wherein the first, second, third, and fifth transistors are N-channel logic level enhancement mode field effect transistor and the fourth transistor is a PNP transistor.

4. The apparatus as claimed in claim 1, further comprising an operational amplifying buffer having an input pin and an output pin, the operational amplifying buffer being coupled to the output of the signal selector for increasing the driving capability of the portable device.

5. The apparatus as claimed in claim 4, further comprising a microprocessor and a digital to analog converter (DAC), the DAC having an input pin coupled to a output pin of the microprocessor and an output pin coupled to the output pin of the operational amplifying buffer, the microprocessor being adapted to execute a program for generating a PWM brightness control signal to control the brightness of the portable device

6. The apparatus as claimed in claim 5, wherein the DAC is integrated into the microprocessor.
